(19) United States
(12) Patent Application Publication
(10) Pub. No.: US 2015/0299975 A1
(43) Pub. Date: Oct. 22, 2015

(54) PREVENTION OF TOPSOIL EROSION WITH HYDROGELS

(71) Applicant: MOASIS INC., Union City, CA (US)

(72) Inventors: Naihong LI, Union City, CA (US); Cameron BLACKFORD, El Cerrito, CA (US)

(21) Appl. No.: 14/423,540

(22) PCT Filed: Aug. 23, 2013
(86) PCT No.: PCT/CA2013/050656

§ 371 Date: Feb. 24, 2015

Related U.S. Application Data
(60) Provisional application No. 61/693,077, filed on Aug. 24, 2012.

(51) Int. Cl. E02D 3/00; C09K 17/52; C09K 17/20; E02D 3/12; A01B 79/00

(52) U.S. Cl. CPC E02D 3/005; E02D 3/126; A01B 79/00; C09K 17/20; C09K 17/52; E02D 2300/0006

(57) ABSTRACT

Methods for reducing or preventing topsoil erosion with hydrogels are described. Upon treatment, a plot of soil may exhibit improved water retention capacity, reduced topsoil erosion and improved aeration properties for plant growth.

### CROSS-REFERENCE TO RELATED APPLICATIONS

This application is related to Patent Cooperation Treaty Patent Application Serial No. PCT/US2011/059837 filed Nov. 9, 2011, and claims priority to U.S. Provisional Patent Application No. 61/693,077 filed Aug. 24, 2012, which applications are hereby incorporated herein by reference in their entirety.

### BACKGROUND

Topsoil erosion has been recognized as a major environmental problem. It occurs when the topsoil is blown away by wind or washed away by water. Topsoil is usually rich in nutrients necessary for plant growth, and is considered a non-renewable resource. The United States alone loses almost 3 tons of topsoil per acre per year according to some estimates. Without topsoil, or in areas of depleted topsoil, plants are less likely to survive or thrive. According to one estimate, annual costs of public and environmental health losses related to soil erosion exceeded US$45 billion worldwide in 1995. In the absence of effective prevention methods, it is anticipated that the problem of topsoil erosion will accelerate along with worldwide population growth and development.

In land with loess soils, accelerated soil erosion by water results in deterioration of soil properties. Such deteriorated soil typically has lower water stability of aggregates, higher density, lower retention of water useful to plants, lower air capacity and air permeability (Ebeid et al. 1995; Shukla and Lab 2005). An unstable aggregate structure contributes to surface crust forming and further water erosion during heavy run-off periods. In addition, cultivated plant crops from eroded soils are usually small and typically lack in nutrients. Restoration of such eroded soils is usually required to regain a stable aggregate structure and to improve water and air properties.

### SUMMARY

The present disclosure provides methods for preventing or reducing topsoil erosion with the aid of gels or hydrogels.

In an aspect of the invention, the present disclosure provides a method for reducing or preventing topsoil erosion, comprising: a) providing a hydrogel, the hydrogel comprising a first polymeric material hydrogen bonded to a second polymeric material, wherein the first polymeric material includes polyacrylic acid and the second polymeric material includes a polyglycol other than polyethylene glycol; b) applying the powered hydrogel to top surface of a plot of soil. In some embodiments, the method comprises spraying water onto the plot of soil. In a further embodiment, the water is sprayed for at least about 1 minute.

In another aspect, the present disclosure provides a method for reducing or preventing topsoil erosion, comprising: a) providing a hydrogel, the hydrogel comprising a first polymeric material hydrogen bonded to a second polymeric material, wherein the first polymeric material includes polyacrylic acid and the second polymeric material includes a polyglycol other than polyethylene glycol; b) mixing the hydrogel with water to form a diluted hydrogel; c) applying the diluted hydrogel to a plot of soil. In some embodiments, the diluted hydrogel is applied only to top surface of the plot of soil. In some embodiment, the weight ratio of hydrogel and water is in a range of about 1:100 to about 100:1.

In another aspect, the present disclosure provides a method for reducing or preventing topsoil erosion, comprising: a) providing a hydrogel, the hydrogel comprising a first polymeric material hydrogen bonded to a second polymeric material, wherein the first polymeric material includes polyacrylic acid and the second polymeric material includes a polyglycol other than polyethylene glycol; b) mixing the hydrogel with an organic material and water to form a mixture; c) applying the mixture to a plot of soil. In some embodiments, the mixture applied only to top surface of the plot of soil. In some embodiments, the weight ratio of hydrogel and water is in a range of about 1:100 to about 100:1. In some embodiments, the organic material is selected from a group consisting of paper mulch, wood fiber mulch, recycled paper, and cellulose.

In a further aspect, the present disclosure provides a method for reducing or preventing topsoil erosion, comprising: a) providing a hydrogel, the hydrogel comprising a first polymeric material hydrogen bonded to a second polymeric material, wherein the first polymeric material includes polyacrylic acid and said second polymeric material includes a polyglycol other than polyethylene glycol; b) mixing the hydrogel with irrigation water at a concentration between about 5 ppm to about 10 ppm; and c) applying the irrigation water comprising the hydrogel to a top surface of a plot of soil. In a particular embodiment, the hydrogel may comprise a potassium salt of the polyacrylic first polymeric material crosslinked such as by hydrogen bonding and/or a crosslinker to the second polymeric material.

Each of the first polymeric material and the second polymeric material may be substantially a homopolymer. In some embodiments, the second polymeric material is polytetramethylene ether glycol. The Mw (g/mol) of the first polymeric material may be in a range between about 250,000 and about 1,000,000 or between about 400,000 and 600,000. The Mw (g/mol) of the second polymeric material may be between about 500 and about 2,000, or between about 650 and 1,000. The ratio, by weight, of the first polymeric material to the second polymeric material may be about 1-to-3, or about 1-to-6.

The hydrogel may remain substantially unchanged after 1, 2, 5, 10, 20, 50, 100 or even more hydration-dehydration cycles. The hydrogel may have a water-retention capacity of at least about 5, 10, 20, 50, 100 times or even more the weight of the hydrogel. The hydrogel has a water-retention capacity of at least about 10%, at least 50%, at least 100%, at least 200%, at least 500%, or at least 1000% of the weight of the hydrogel.

A treated plot of soil may desirably provide for a reduction in topsoil erosion compared to that of an untreated plot of soil. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in a given time period such as a month. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in 3 months. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in 6 months. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in 1 year. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in 2 years.

A treated plot of soil may yield stronger and/or nutritious plants compared to plants grown on an untreated plot of soil. In some embodiments, the treated plot of soil yields a plant comprising a leaf having at least twice the mass than a leaf yielded by a plot of soil lacking hydrogel treatment.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference in their entirety, and to the same extent as if each individual publication, patent, or patent application was specifically and individually indicated to be incorporated by reference.

### BRIEF DESCRIPTION OF THE DRAWINGS

FIG. 1 illustrates a graph showing average irrigation runoff water turbidity level measurements for each of control, 5 ppm and 10 ppm hydrogel treatment levels, according to an exemplary embodiment of the present invention.

FIG. 2 illustrates a graph showing the average reduction in average irrigation runoff water turbidity level measurements compared to the control for each of control, 5 ppm and 10 ppm hydrogel treatment levels, according to a further exemplary embodiment of the present invention

### DETAILED DESCRIPTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention.

One aspect of the present disclosure provides methods to reduce or prevent topsoil erosion—a global environmental problem. One embodiment of the invention is based at least in part on the unexpected realization that the combination of certain components, comprising hydrogels provided herein, can lead to the formation of a mixture with properties that are suited for certain applications, such as reducing or preventing topsoil erosion. For example, a hydrogel having polyacrylic acid and polytetramethylene ether glycol may be environmentally friendly and may desirably not lead to environmental contamination during extended use. The ability of such hydrogel to retain water, nutrients, and/or topsoil makes it suitable for combating topsoil erosion. In some situations, such hydrogels are readily formed at temperatures at or near room temperature without the application of heat and, in some cases, without the aid of a catalyst.

The term “polymeric material,” as used herein, includes a material having one or more monomeric subunits (also “units” herein). In an embodiment, a polymeric material can include one or more types of repeating subunits. In another embodiment, a polymeric material can include the same type of repeating subunit. In another embodiment, a polymeric material can include two or more different types of repeating subunits. In another embodiment, a polymeric material can include monomeric subunits bonded to one another. In another embodiment, a polymeric material can include monomeric subunits bonded to another with the aid of covalent bonds.

The term “gel,” as used herein, can include a material comprising one or more types of polymeric materials bonded together. A gel may be a hydrogel. In an embodiment, a hydrogel (also “polymeric hydrogel” herein) can include one or more types of polymeric materials bonded together to form a three-dimensional structure. In another embodiment, a hydrogel can include two types of polymeric materials bonded together to form a three-dimensional structure (or three-dimensional network). In another embodiment, a hydrogel can include one or more types of polymeric materials bonded to one another with the aid of hydrogen bonds. In another embodiment, a hydrogel can include one or more types of polymeric materials bonded to one another substantially or solely by hydrogen bonds. In another embodiment, a first polymeric material having one or more monomeric subunits is hydrogen-bonded to a second polymeric material having one or more monomeric subunits. In another embodiment, the hydrogen bonds are formed between hydrogen atoms of a first polymeric material and electronegative atoms (e.g., oxygen, nitrogen or fluorine) such as of a second polymeric material.

The term “homopolymer,” as used herein, is any polymeric substance that is composed of the same kind of a monomer. For example, homopolymer of acrylic acid is a polymer that is composed only of acrylic acid. The phrase “substantially a homopolymer,” as used herein, refers to a polymeric material that is composed of about 80%, or about 81%, or about 82%, or about 83%, or about 84%, or about 85%, or about 86%, or about 87%, or about 88%, or about 89%, or about 90%, or about 91%, or about 92%, or about 93%, or about 94%, or about 95%, or about 96%, or about 97%, or about 98%, or about 99%, or about 99.5%, or about 99.9%, or about 99.95%, of the same kind of monomer unit. For example, when a material having polyacrylic acid is substantially a homopolymer, at least 80% of the material is composed of acrylic acid monomer units. For another example, when a material having a polyglycol is substantially a homopolymer, at least 80% of the material is composed of the same glycol monomer units. For example, when a polymeric material having polytetramethylene ether glycol (“PTMEG”) is substantially a homopolymer, it is composed of at least 80% of polytetramethylene ether glycol monomer units.

The term “soil,” as used herein, refers to a natural geological material including one or more layers that are primarily composed of mineral and/or organic materials which may differ from their parent materials in their texture, structure, consistency, colour, chemical, biological and other characteristics. Soil may be an unconsolidated or loose covering of fine rock particles, weathered rock-sourced minerals and/or organic materials that typically covers the surface of the earth. In some cases, soil is the end product of the influence of the climate (temperature, precipitation), relief (slope), organisms (flora and fauna), parent materials (original minerals and/or organic materials), temperature, and time. Soil may be referred to as “earth” or, in some cases, “dirt.”

The phrase “substantially unchanged,” as used herein, refers to hydrogels that exhibit about the same mass after a hydration-dehydration cycle as before a hydration-dehydration cycle.

### Method of Reducing or Preventing Topsoil Erosion

In one aspect, the present disclosure provides a method for reducing or preventing topsoil erosion, comprising: a) providing a hydrogel, the hydrogel comprising a first polymeric material hydrogen bonded to a second polymeric material, wherein the first polymeric material includes polyacrylic acid and the second polymeric material includes a polyglycol other than polyethylene glycol; b) applying the powdered hydrogel to a top surface of a plot of soil.

In some cases, a hydrogel is solely applied to a top surface of a plot of soil. In some examples, the hydrogel may be applied by depositing the hydrogel from a container to the top surface of the plot of soil. The hydrogel in some cases can be applied to the top surface and subsequently mixed with the plot of soil to occupy a given depth of the plot of soil.

The hydrogel may be in a powder, particle, semi-liquid or liquid form. The method may further comprise a step of spraying water onto the plot of soil. In one embodiment, the water may be sprayed for at least about 1 minute, at least about 2 minute, at least about 5 minute, at least about 10 minute, at least about 20 minute, at least about 30 minute, at least about 40 minute, at least about 50 minute, at least about 60 minute, at least about 90 minute, at least about 120 minute, at least about 1 day, at least about 2 days, at least about 1 week, or at least about 2 weeks. The water may be sprayed in several blocks of time during a day, a week, a month, or even a year. Alternatively, if the hydrogel is applied to the plot of soil during or after rain, additional spraying of water may not be needed.

In another aspect, the present disclosure provides a method for reducing or preventing topsoil erosion, comprising: a) providing a hydrogel, the hydrogel comprising a first polymeric material hydrogen bonded to a second polymeric material, wherein the first polymeric material includes polyacrylic acid and the second polymeric material includes a polyglycol other than polyethylene glycol; b) mixing the hydrogel with water to form a diluted hydrogel; c) applying the diluted hydrogel to a plot of soil. In some embodiments, the mixture applied only to a top surface of the plot of soil.

In another aspect, the present disclosure provides a method for reducing or preventing topsoil erosion, comprising: a) providing a hydrogel, the hydrogel comprising a first polymeric material hydrogen bonded to a second polymeric material, wherein the first polymeric material includes polyacrylic acid and the second polymeric material includes a polyglycol other than polyethylene glycol; b) mixing the hydrogel with an organic material and water to form a mixture; c) applying the mixture to a plot of soil. In some embodiments, the mixture applied only to a top surface of the plot of soil. In some embodiments, the organic material is selected from a group consisting of paper mulch, wood fiber mulch, recycled paper, and cellulose.

In a further aspect, the present disclosure provides a method for reducing or preventing topsoil erosion, comprising: a) providing a hydrogel, the hydrogel comprising a first polymeric material hydrogen bonded to a second polymeric material, wherein the first polymeric material includes polyacrylic acid and said second polymeric material includes a polyglycol other than polyethylene glycol; b) mixing the hydrogel with irrigation water at a concentration between about 5 ppm to about 10 ppm; and c) applying the irrigation water comprising the hydrogel to a top surface of a plot of soil. In a particular embodiment, the hydrogel may comprise a potassium salt or derivative of the polyacrylic first polymeric material crosslinked such as by hydrogen bonding and/or a crosslinker to the second polymeric material.

In one embodiment, the weight ratio of the hydrogel and water may be controlled based on a variety of factors, for example, properties of the hydrogel, properties of the plot of soil, intended use of the soil, season and local weather conditions, and machines and methods for applying the hydrogel. The weight ratio of hydrogel to water may be in a range of about 1:100 to about 100:1. In some embodiments, the weight ratio of hydrogel to water is about 1:95, about 1:90, about 1:85, about 1:80, about 1:75, about 1:70, about 1:65, about 1:60, about 1:55, about 1:50, about 1:45, about 1:40, about 1:35, about 1:30, about 1:25, about 1:20, about 1:15, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, or about 100:1.

The organic material may be an organic material which contains nutrients, for example, sugars, cellulose, minerals, nitrogen, phosphorus, and amino acids. The organic material may be derived from terrestrial sources, for example, animals and plants. The organic material may be derived from marine sources, for example, coral, sponges, fish, sea weed, algae, and other marine microorganisms. In some embodiments, the organic material is selected from a group consisting of paper mulch, wood fiber mulch, recycled paper, and cellulose. Optionally, additional nutrients such as sugar, cellulose, minerals, amino acid or any mixture thereof is added to the organic material. The weight ratio of the hydrogel to the organic material may be in a range of about 1:100 to about 100:1. In some embodiments, the weight ratio of the hydrogel to the organic material is about 1:95, about 1:90, about 1:85, about 1:80, about 1:75, about 1:70, about 1:65, about 1:60, about 1:55, about 1:50, about 1:45, about 1:40, about 1:35, about 1:30, about 1:25, about 1:20, about 1:15, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, or about 100:1.

In one embodiment, the amount of hydrogel applied to a plot of soil may be determined based on effectiveness in reduction of soil erosion and may depend on factors such as soil type, irrigation type, plant or crop type, topography, or other factors, such as may be determined experimentally or by trial and error. In a particular embodiment, the amount of hydrogel applied to a plot of soil may be, in a range of about 10 g per acre to about 10,000 g (10 kg) per acre, including for example about 10 g per acre, about 15 g per acre, about 20 g per acre, about 25 g per acre, about 30 g per acre, about 35 g per acre, about 40 g per acre, about 45 g per acre, about 50 g per acre, about 55 g per acre, about 60 g per acre, about 65 g per acre, about 70 g per acre, about 75 g per acre, about 80 g per acre, about 85 g per acre, about 90 g per acre, about 95 g per acre, about 100 g per acre, about 110 g per acre, about 120 g per acre, about 130 g per acre, about 140 g per acre, about 150 g per acre, about 200 g per acre, about 300 g per acre, about 400 g per acre, about 500 g per acre, about 600 g per acre, about 700 g per acre, about 750 g per acre, about 800 g per acre, about 900 g per acre, about 1,000 g per acre, about 1,200 g per acre, about 1,500 g per acre, about 2,000 g per acre, about 3,000 g per acre, about 4,000 g per acre, about 5,000 g per acre, about 6000 g per acre, about 7000 g per acre, about 8000 g per acre, about 9000 g per acre or about 10,000 g per acre, for example.

In some cases, treatment of a plot of soil may last 1 day, 1 week, 1 month, 1 year, 2 years, 3 years, 5 years, or even 10 years. The hydrogel may be applied to the soil at least once every 10 years, once every 5 years, once every 2 years, once every year, once every 6 months, once every 3 months, once every month, or once every week. The treated plot of soil may desirably have reduced topsoil erosion. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in a month. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in 3 months. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in 6 months. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in 1 year. In some embodiments, topsoil erosion of the treated plot of soil may be reduced by at least 20%, at least 30%, at least 40%, at least 50%, at least 60%, at least 70%, at least 80%, or at least 90% compared to that of an untreated plot of soil in 2 years.

In one embodiment, plants grown on a treated plot of soil may be stronger than plants gown on a comparable, untreated plot of soil. In some embodiments, a treated plot of soil yields a plant comprising a leaf having at least about 1.2 times, at least about 1.5 times, at least about 2 times, at least about 2.5 times, at least about 3 times, or at least about 5 times the mass compared to a leaf yielded by plot of soil lacking hydrogel treatment. Fruits grown on a treated plot of soil may be heavier on average than fruits grown on a comparable, untreated plot of soil. In some embodiments, a treated plot of soil yields fruits having at least about 1.2 times, at least about 1.5 times, at least about 2 times, at least about 2.5 times, at least about 3 times, or at least about 5 times the mass compared to fruits yielded by a comparable plot of soil lacking hydrogel treatment.

A treated plot of soil may have improved water-retention capabilities than a comparable, untreated plot of soil. The water-retention capabilities may be improved by at least about 20%, at least about 30%, at least about 40%, at least about 50%, at least about 60%, at least about 70%, at least about 80%, or at least about 90%.

### Hydrogels

In several embodiments, hydrogels may be in powdered or particulate form or liquid form unless specified. It is understood by one of skilled in the art that upon mixing with water or an aqueous mixture, powdered or particulate hydrogels can be turned into a liquid.

A hydrogel used in at least one of the embodiments of the disclosure may be a three-dimensional (“3D”) hydrogel. The three-dimensional hydrogel may comprise two or more polymeric materials. The two or more polymeric materials may be hydrogen bonded to one another. The polymeric materials can be hydrogen bonded to one another through one or more subunits of the polymeric materials. In some cases, the hydrogel includes 1 or more, 2 or more, 3 or more, 4 or more, 5 or more, 6 or more, 7 or more, 8 or more, 9 or more, or 10 or more types of polymeric materials that are hydrogen bonded to one another.

A hydrogel may have a first polymeric material and a second polymeric material. In some cases, the first polymeric material is cross-linked to the second polymeric material. In some cases, the first polymeric material is hydrogen-bonded to the second polymeric material. In some cases, the first polymeric material is linked to the second polymeric material exclusively through hydrogen-bonding interactions. In some cases, the first polymeric material is linear polyacrylic acid (“PAA”) and the second polymeric material is a polyglycol. In some cases, the first polymeric material is PAA and the second polymeric material is polytetramethylene ether glycol (“PTMEG”). In some cases, the hydrogel includes a third polymeric material. The third polymeric material may be hydrogen-bonded to the second polymeric material. Alternatively, the third polymeric material may be hydrogen-bonded to the first polymeric material. Alternatively, the third polymeric material may be hydrogen-bonded to the first and second polymeric materials. In some cases, the first polymeric material is PAA, the second polymeric material is a polyglycol, and the third polymeric material is polyacrylamide (“PAM”). In some cases, the first polymeric material is PAA, the second polymeric material is PTMEG, and the third polymeric material is PAM. In some cases, the first polymeric material is PAA, the second polymeric material is PTMEG, and the third polymeric material is polyvinyl alcohol. In such cases, the third polymeric material may be covalently bonded to the first polymeric material.

In one embodiment, PAA can be obtained from recycled polyacrylic acid, such as polyacrylic acid extracted from used diapers. In some cases, additional processing may be necessary to prepare the recycled polyacrylic acid for use with hydrogels and for use in preparation of hydrogels provided herein.

In one embodiment, a hydrogel may comprise polyacrylic acid (or poly(acrylic acid), “PAA”) and a polyglycol. The hydrogel may further comprise the monomer of acrylic acid. In some cases, the hydrogel comprises a vinyl-containing monomer (also referred to as “vinyl-containing material” herein), including acrylamide, methylacrylic acid, vinyl alcohol, vinyl acetate, butyl acrylate, vinyl acrylate, vinylbenzoic acid, vinylbenzyl alcohol, vinylboronic acid dibutyl ester, vinylformamide, vinyl methacrylate, vinylpyridine, 1-vinyl-2-pyrrolidone, vinylsulfonic acid and vinyltrimethoxysilane. In some cases, the hydrogel comprises a vinyl-containing polymer (also referred to as “vinyl-containing material” herein). When a vinyl-containing material is an acid, the hydrogel may comprise a salt derivative of the acid. For example, when the monomer is acrylic acid, the hydrogel may comprise a sodium or potassium salt of acrylic acid, or a sodium or potassium salt of polyacrylic acid. In some cases, the vinyl-containing material may be covalently bonded to polyacrylic acid.

Alternatively, a hydrogel may comprise poly(acrylic acid) (“PAA”) and one or more polyglycols, the one or more polyglycols selected from polyethylene glycol (PEG), polytetramethylene ether glycol (PTMEG), and polypropylene ether glycol (PPG). PPG, while providing a polymeric hydrogel of desirable high softness, is infrequently used in applications intended for medical use because PPG requires a catalyst for reaction with isocyanates. In some cases, the hydrogel comprises PAA and PEG. In some cases, the hydrogel comprises PAA and PTMEG. In some cases, the hydrogel comprises PAA and PPG.

Alternatively, a gel, including a hydrogel, may comprise a first polymeric material and a second polymeric material, the second polymeric material having —O—(CH₂)ₙ subunits, wherein ‘n’ is a number greater than or equal to 2, or 3, or 4, or 5, or 6, or 7, or 8, or 9, or 10, or 11, or 12, or 13, or 14, or 15, or 16, or 17, or 18, or 19, or 20. ‘n’ may be greater than or equal to 2, greater than or equal to 3, or greater than or equal to 4. The second polymeric material may be PTMEG. Additionally, the hydrogel may include a third polymeric material. In some cases, the hydrogel may include hydrogen-bonding interactions between polymeric materials.

Alternatively, in another embodiment, a hydrogel may comprise a first polymeric material and a second polymeric material, the second polymeric material having —O—(CH₂CH₂)ₘ subunits, wherein ‘m’ is a number greater than or equal to 1, or 2, or 3, or 4, or 5, or 6, or 7, or 8, or 9, or 10, or 11, or 12, or 13, or 14, or 15, or 16, or 17, or 18, or 19, or 20. In some cases, ‘m’ is greater than or equal to 2. In such a case, the second polymeric material can be PTMEG. In some cases, ‘m’ is greater than or equal to 3. In some cases, ‘m’ is greater than or equal to 4. In an example, the first polymeric material can include a polymeric material that is hydrogen bonded to the second polymeric material. In some cases, the first polymeric material can include PAA. In some cases, the hydrogel can include hydrogen-bonding interactions between polymeric materials.

In a further embodiment, a three-dimensional hydrogel structure may be formed by mixing polyacrylic acid and a polyglycol, thereby providing a material where the two components interact through their hydrogen bonds only. In some cases, a hydrogel is formed by heating a mixture having polyacrylic acid and the polyglycol. The properties of the mixed material are different from the starting materials. The linear polyacrylic acid may be provided as a powder, and the polyglycol is a viscous liquid at room temperature. In some cases, the mixed material is a rubber-like solid (i.e., having a viscosity similar to rubber or rubber-like materials). In some cases, the mixed material cannot be appreciably dissolved in any solvents, either organic solvents or water.

Alternatively, a hydrogel may comprise polyacrylic acid (PAA) and a polyglycol having average molecular weights selected to provide hydrogel properties as desired. The hydrogel may comprise PAA and PTMEG having average molecular weights selected to provide hydrogel properties as desired.

Alternatively, a hydrogel may comprise PAA having an average molecular weight (M_{w}) between about 1,800 to about 4,000,000 (g/mol). In some cases, the hydrogel comprises a polyglycol having an average molecular weight (M_{w}) of at least about 250, or at least about 650, or at least about 1000, or at least about 2000, or at least about 3000.

The ratio, by weight, of the first polymeric material to the second polymeric material may be about 1-to-1, or about 1-to-2, or about 1-to-3, or about 1-to-6, or about 1-10, or about 1-20, or about 2-to-1, or about 3-to-1, or about 4-to-1, or about 5-to-1, or about 6-to-1, or about 10-to-1, or about 20-to-1, or more.

Alternatively, a hydrogel comprising a first polymeric material and a second polymeric material may be blended with polyethylene. The blend of polyethylene and a hydrogel comprising a first polymeric material and a second polymeric material may exhibit an impact strength and/or a tensile strength higher than that of the polyethylene by itself.

### Environmentally Friendly Hydrogels

According to some embodiments, environmentally friendly hydrogels may desirably be non-toxic and/or biodegradable. Non-toxic and biodegradable hydrogels can be prepared according to one embodiment by using a first polymeric material, such as polyacrylic acid, and a second polymeric material, such as an environmentally friendly polyglycol. Such non-toxic and biodegradable hydrogels can be friendly to the environment (also referred to as “environmentally-friendly hydrogels” herein), as they minimize, if not eliminate, the production of hazardous components, thereby minimizing, if not eliminating, the risk of hazardous components from entering (or leaching into) water supplies, for example. In some embodiments, the environmentally friendly polyglycol is polytetramethylene ether glycol (PTMEG). In some embodiments, the first polymeric material is substantially a homopolymer. In some embodiments, the environmentally friendly polyglycol is a homopolymer. In some embodiments, the first polymeric material, such as polyacrylic acid, is hydrogen-bonded to the environmentally friendly polyglycol. In some embodiments, an environmentally friendly polyglycol excludes polyethylene glycol.

An environmentally friendly hydrogel may be blended with polyethylene. A blend of an environmentally friendly hydrogel and polyethylene can exhibit higher impact strength than that of the polyethylene by itself. In some cases, a blend of an environmentally friendly hydrogel and polyethylene can exhibit higher tensile strength than that of the polyethylene by itself.

An environmentally friendly hydrogel may exhibit properties as described for hydrogels below. In some embodiments, an environmentally friendly hydrogel can be further combined with an environmentally friendly polymer that is not a polyglycol as described below, such as cellulose. In some embodiments, an environmentally friendly hydrogel is formed by the methods described below. In some embodiments, an environmentally friendly hydrogel has a composition as described above. In some embodiments, an environmentally friendly hydrogel is blended with a material such as fertilizer or soil to provide a blend material with high water-retention capacity.

An environmentally friendly hydrogel comprising an environmentally friendly polyglycol can be advantageous over hydrogels that comprise toxic polyglycols in that a wider range of uses may be available for hydrogels that do not contain toxic materials. For example, an environmentally friendly hydrogel can be used in agricultural or medical applications, or combined with environmentally friendly polymers to provide a blend that is compatible with uses in medicine and agriculture. Further applications of environmentally friendly hydrogels are described.

### Methods for Forming Hydrogels

In one embodiment of the present invention, methods for forming hydrogels (also “hydrogel-like substances” herein), including three-dimensional (“3D”) hydrogels, may involve a first process and a second process. The first process may be used to form a first polymeric material and a second process may be used to form a second polymeric material. The first and second polymeric materials may be mixed together to form a hydrogel. The polymeric materials can be mixed in a reaction vessel or chamber, such as, for example, a beaker, tub, tank or vat. In some cases, the polymeric material can be added to the reaction vessel under continuous stirring conditions.

In one aspect, a method for forming a hydrogel or hydrogel-like substance may include combining a first polymeric material and a second polymeric material to form a hydrogel having the first polymeric material bonded to the second polymeric material via hydrogen bonds between subunits of the first and second polymeric materials.

In one example, a hydrogel may be formed by mixing a first polymeric material having PAA with a second polymeric material having a polyglycol (e.g., PEG, PTMEG, PPG) at room temperature. In some cases, the second polymeric material excludes polyethylene glycol. In another embodiment, a hydrogel is formed by mixing a first polymeric material having PAA with a second polymeric material having a polyglycol (e.g., PEG, PTMEG, PPG) at a temperature between about 15° C. and 35° C., or 15° C. and 30° C., or 20° C. and 30° C., or 22° C. and 27° C. In another embodiment, a hydrogel is formed by mixing a first polymeric material having PAA with a second polymeric material having a polyglycol at a temperature of about 15.0° C., or 15.1° C., or 15.2° C., or 15.3° C., or 15.4° C., or 15.5° C., or 15.6° C., or 15.7° C., or 15.8° C., or 15.9° C., or 16.0° C., or 16.1° C., or 16.2° C., or 16.3° C., or 16.4° C., or 16.5° C., or 16.6° C., or 16.7° C., or 16.8° C., or 16.9° C., or 17.0° C., or 17.1° C., or 17.2° C., or 17.3° C., or 17.4° C., or 17.5° C., or 17.6° C., or 17.7° C., or 17.8° C., or 17.9° C., or 18.0° C., or 18.1° C., or 18.2° C., or 18.3° C., or 18.4° C., or 18.5° C., or 18.6° C., or 18.7° C., or 18.8° C., or 18.9° C., or 19.0° C., or 19.1° C., or 19.2° C., or 19.3° C., or 19.4° C., or 19.5° C., or 19.6° C., or 19.7° C., or 19.8° C., or 19.9° C., or 20.0° C., or 20.1° C., or 20.2° C., or 20.3° C., or 20.4° C., or 20.5° C., or 20.6° C., or 20.7° C., or 20.8° C., or 20.9° C., or 21.0° C., or 21.1° C., or 21.2° C., or 21.3° C., or 21.4° C., or 21.5° C., or 21.6° C., or 21.7° C., or 21.8° C., or 21.9° C., or 22.0° C., or 22.1° C., or 22.2° C., or 22.3° C., or 22.4° C., or 22.5° C., or 22.6° C., or 22.7° C., or 22.8° C., or 22.9° C., or 23.0° C., or 23.1° C., or 23.2° C., or 23.3° C., or 23.4° C., or 23.5° C., or 23.6° C., or 23.7° C., or 23.8° C., or 23.9° C., or 24.0° C., or 24.1° C., or 24.2° C., or 24.3° C., or 24.4° C., or 24.5° C., or 24.6° C., or 24.7° C., or 24.8° C., or 24.9° C., or 25.0° C., or 25.1° C., or 25.2° C., or 25.3° C., or 25.4° C., or 25.5° C., or 25.6° C., or 25.7° C., or 25.8° C., or 25.9° C., or 26.0° C., or 26.1° C., or 26.2° C., or 26.3° C., or 26.4° C., or 26.5° C., or 26.6° C., or 26.7° C., or 26.8° C., or 26.9° C., or 27.0° C., or 27.1° C., or 27.2° C., or 27.3° C., or 27.4° C., or 27.5° C., or 27.6° C., or 27.7° C., or 27.8° C., or 27.9° C., or 28.0° C., or 28.1° C., or 28.2° C., or 28.3° C., or 28.4° C., or 28.5° C., or 28.6° C., or 28.7° C., or 28.8° C., or 28.9° C., or 29.0° C., or 29.1° C., or 29.2° C., or 29.3° C., or 29.4° C., or 29.5° C., or 29.6° C., or 29.7° C., or 29.8° C., or 29.9° C., or 30.0° C., or 31.0° C., or 31.1° C., or 31.2° C., or 31.3° C., or 31.4° C., or 31.5° C., or 31.6° C., or 31.7° C., or 31.8° C., or 31.9° C., or 32.0° C., or 32.1° C., or 32.2° C., or 32.3° C., or 32.4° C., or 32.5° C., or 32.6° C., or 32.7° C., or 32.8° C., or 32.9° C., or 33.0° C., or 33.1° C., or 33.2° C., or 33.3° C., or 33.4° C., or 33.5° C., or 33.6° C., or 33.7° C., or 33.8° C., or 33.9° C., or 34.0° C., or 34.1° C., or 34.2° C., or 34.3° C., or 34.4° C., or 34.5° C., or 34.6° C., or 34.7° C., or 34.8° C., or 34.9° C., or 35.0° C.

According to a further embodiment, a hydrogel may be formed by mixing a first polymeric material having PAA with a second polymeric material having one or more of PEG, PTMEG, and PPG at room temperature. In some cases, the second polymeric material excludes polyethylene glycol. In another embodiment, a hydrogel is formed by mixing a first polymeric material having PAA with a second polymeric material having a polyglycol (e.g., PEG, PTMEG, PPG) at a temperature between about 15° C. and 35° C., or 15° C. and 30° C., or 20° C. and 30° C., or 22° C. and 27° C. In another embodiment, a hydrogel is formed by mixing a first polymeric material having PAA with a second polymeric material having one or more of PEG, PTMEG, and PPG at a temperature of about 15.0° C., or 15.1° C., or 15.2° C., or 15.3° C., or 15.4° C., or 15.5° C., or 15.6° C., or 15.7° C., or 15.8° C., or 15.9° C., or 16.0° C., or 16.1° C., or 16.2° C., or 16.3° C., or 16.4° C., or 16.5° C., or 16.6° C., or 16.7° C., or 16.8° C., or 16.9° C., or 17.0° C., or 17.1° C., or 17.2° C., or 17.3° C., or 17.4° C., or 17.5° C., or 17.6° C., or 17.7° C., or 17.8° C., or 17.9° C., or 18.0° C., or 18.1° C., or 18.2° C., or 18.3° C., or 18.4° C., or 18.5° C., or 18.6° C., or 18.7° C., or 18.8° C., or 18.9° C., or 19.0° C., or 19.1° C., or 19.2° C., or 19.3° C., or 19.4° C., or 19.5° C., or 19.6° C., or 19.7° C., or 19.8° C., or 19.9° C., or 20.0° C., or 20.1° C., or 20.2° C., or 20.3° C., or 20.4° C., or 20.5° C., or 20.6° C., or 20.7° C., or 20.8° C., or 20.9° C., or 21.0° C., or 21.1° C., or 21.2° C., or 21.3° C., or 21.4° C., or 21.5° C., or 21.6° C., or 21.7° C., or 21.8° C., or 21.9° C., or 22.0° C., or 22.1° C., or 22.2° C., or 22.3° C., or 22.4° C., or 22.5° C., or 22.6° C., or 22.7° C., or 22.8° C., or 22.9° C., or 23.0° C., or 23.1° C., or 23.2° C., or 23.3° C., or 23.4° C., or 23.5° C., or 23.6° C., or 23.7° C., or 23.8° C., or 23.9° C., or 24.0° C., or 24.1° C., or 24.2° C., or 24.3° C., or 24.4° C., or 24.5° C., or 24.6° C., or 24.7° C., or 24.8° C., or 24.9° C., or 25.0° C., or 25.1° C., or 25.2° C., or 25.3° C., or 25.4° C., or 25.5° C., or 25.6° C., or 25.7° C., or 25.8° C., or 25.9° C., or 26.0° C., or 26.1° C., or 26.2° C., or 26.3° C., or 26.4° C., or 26.5° C., or 26.6° C., or 26.7° C., or 26.8° C., or 26.9° C., or 27.0° C., or 27.1° C., or 27.2° C., or 27.3° C., or 27.4° C., or 27.5° C., or 27.6° C., or 27.7° C., or 27.8° C., or 27.9° C., or 28.0° C., or 28.1° C., or 28.2° C., or 28.3° C., or 28.4° C., or 28.5° C., or 28.6° C., or 28.7° C., or 28.8° C., or 28.9° C., or 29.0° C., or 29.1° C., or 29.2° C., or 29.3° C., or 29.4° C., or 29.5° C., or 29.6° C., or 29.7° C., or 29.8° C., or 29.9° C., or 30.0° C., or 31.0° C., or 31.1° C., or 31.2° C., or 31.3° C., or 31.4° C., or 31.5° C., or 31.6° C., or 31.7° C., or 31.8° C., or 31.9° C., or 32.0° C., or 32.1° C., or 32.2° C., or 32.3° C., or 32.4° C., or 32.5° C., or 32.6° C., or 32.7° C., or 32.8° C., or 32.9° C., or 33.0° C., or 33.1° C., or 33.2° C., or 33.3° C., or 33.4° C., or 33.5° C., or 33.6° C., or 33.7° C., or 33.8° C., or 33.9° C., or 34.0° C., or 34.1° C., or 34.2° C., or 34.3° C., or 34.4° C., or 34.5° C., or 34.6° C., or 34.7° C., or 34.8° C., or 34.9° C., or 35.0° C. In another embodiment, a hydrogel is formed by mixing a first polymeric material having PAA with a second polymeric material having one or more of PEG, PTMEG, and PPG at a temperature between about 25° C. to about 30° C.

In a further aspect, a hydrogel-like substance may be formed by mixing polyacrylic acid (“PAA”) and polytetramethylene glycol (“PTMEG”), also known as poly(tetramethylene ether glycol). PTMEG can be used to form polyurethanes and other polymeric materials (also “polymers” herein) that have been approved for medical and dental uses, among others. In another embodiment, a hydrogel-like substance is formed by combining a powder of polyacrylic acid (PAA) and a viscous solution of polyglycol to form a mixture, and continuously stirring the mixture at room temperature. In an embodiment, PAA and a polyglycol can be combined at a temperature between about 15° C. and 35° C. or 20° C. and 30° C. to form a hydrogel without the use of a catalyst (e.g., heterogeneous or homogeneous catalyst). In an embodiment, a hydrogel is formed without the use of a heterogeneous catalyst. In another embodiment, a hydrogel is formed without the use of a homogenous catalyst.

In one example, a hydrogel may be formed by mixing PAA with a polyglycol at a ratio (by weight) of about 0.1 to 1, or 0.2 to 1, or 0.3 to 1, or 0.4 to 1, or 0.5 to 1, or 0.6 to 1, or 0.7 to 1, or 0.8 to 1, or 0.9 to 1, or 1 to 1, or 1.1 to 1, or 1.2 to 1, or 1.3 to 1, or 1.4 to 1, or 1.5 to 1, or 1.6 to 1, or 1.7 to 1, or 1.8 to 1, or 1.9 to 1, or 2 to 1. In another embodiment, a hydrogel is formed by mixing PAA with a polyglycol at a ratio of about 0.1 to 1, or 0.11 to 1, or 0.12 to 1, or 0.13 to 1, or 0.14 to 1, or 0.15 to 1, or 0.16 to 1, or 0.17 to 1, or 0.18 to 1, or 0.19 to 1, or 0.2 to 1, or 0.21 to 1, or 0.22 to 1, or 0.23 to 1, or 0.24 to 1, or 0.25 to 1, or 0.26 to 1, or 0.27 to 1, or 0.28 to 1, or 0.29 to 1, or 0.3 to 1, or 0.31 to 1, or 0.32 to 1, or 0.33 to 1, or 0.34 to 1, or 0.35 to 1, or 0.36 to 1, or 0.37 to 1, or 0.38 to 1, or 0.39 to 1, or 0.4 to 1, or 0.41 to 1, or 0.42 to 1, or 0.43 to 1, or 0.44 to 1, or 0.45 to 1, or 0.46 to 1, or 0.47 to 1, or 0.48 to 1, or 0.49 to 1, or 0.5 to 1.

In a further example, a hydrogel may be formed by mixing PAA with PTMEG (also “PTMG” herein) at a ratio (by weight) of about 0.1 to 1, or 0.2 to 1, or 0.3 to 1, or 0.4 to 1, or 0.5 to 1, or 0.6 to 1, or 0.7 to 1, or 0.8 to 1, or 0.9 to 1, or 1 to 1, or 1.1 to 1, or 1.2 to 1, or 1.3 to 1, or 1.4 to 1, or 1.5 to 1, or 1.6 to 1, or 1.7 to 1, or 1.8 to 1, or 1.9 to 1, or 2 to 1. In another embodiment, a hydrogel is formed by mixing PAA with PTMEG at a ratio (by weight) of about 0.1 to 1, or 0.11 to 1, or 0.12 to 1, or 0.13 to 1, or 0.14 to 1, or 0.15 to 1, or 0.16 to 1, or 0.17 to 1, or 0.18 to 1, or 0.19 to 1, or 0.2 to 1, or 0.21 to 1, or 0.22 to 1, or 0.23 to 1, or 0.24 to 1, or 0.25 to 1, or 0.26 to 1, or 0.27 to 1, or 0.28 to 1, or 0.29 to 1, or 0.3 to 1, or 0.31 to 1, or 0.32 to 1, or 0.33 to 1, or 0.34 to 1, or 0.35 to 1, or 0.36 to 1, or 0.37 to 1, or 0.38 to 1, or 0.39 to 1, or 0.4 to 1, or 0.41 to 1, or 0.42 to 1, or 0.43 to 1, or 0.44 to 1, or 0.45 to 1, or 0.46 to 1, or 0.47 to 1, or 0.48 to 1, or 0.49 to 1, or 0.5 to 1. In another embodiment, a hydrogel is formed by mixing PAA with PTMEG (also “PTMG” herein) at a ratio (by weight) of about 1 to 3 (PAA to PTMEG).

In some cases, upon mixing PAA and a polyglycol, a hydrogel is formed having cross linkages between the PAA and polyglycol moieties of the hydrogel—that is, cross linkages between the PAA polymer and the polyglycol polymer of the hydrogel. The formation of cross linkages can depend on the formation of hydrogen bonds between the COOH group of polyacrylic acid and the —O—R—O— group of the polyglycol. In an embodiment, the formation of cross linkages can depend on the formation of hydrogen bonds between the COOH group of PAA and the —O—R—O— group of PTMEG.

In some cases, using PTMEG, block materials (e.g., soft or hard block materials), films and particles can be formed with high compressive and tensile strengths. In another embodiment, a blend material formed from polyacrylic acid and polytetramethylene glycol can also be prepared from one or both of an organic solvent system and aqueous system.

According to one embodiment, a hydrogel may be formed at room temperature (e.g., between about 15° C. and 35° C., or between about 20° C. and 30° C.) without adding any heat to a mixture of components of the hydrogel. In some case, a hydrogel is formed by mixing PAA and a polyglycol at room temperature without adding heat to the mixture. In some case, a hydrogel is formed by mixing PAA and PTMEG at room temperature without adding heat to the mixture. This can advantageously enable savings in processing costs.

According to another embodiment, a hydrogel may be formed at atmospheric or nearly atmospheric pressure. In some cases, a hydrogel is formed by mixing PAA and a polyglycol at atmospheric or nearly atmospheric pressure. In some cases, a hydrogel is formed by mixing PAA and PTMEG at atmospheric or nearly atmospheric pressure. This can advantageously preclude the use of high-pressure equipment, such as pressure chambers, compressors and pumps, thus providing for savings in processing costs. In some cases, a hydrogel is formed by mixing PAA and a polyglycol under vacuum conditions. In some cases, hydrogel is formed by mixing PAA and PTMEG under vacuum conditions.

In one embodiment, at a temperature between about 15° C. and 35° C., or 20° C. and 30° C. and atmospheric or nearly atmospheric pressure, PAA can be a crystalline powder and PTMEG can be a viscous material, such as a soft wax (which can become a free-flowing liquid under mild heating).

In another embodiment, a hydrogel may be formed by mixing PAA and PTMEG at a ratio, by weight, of about 1 to 3 (PAA to PTMEG). In another embodiment, PAA (e.g., PAA powder) can be added to PTMEG while continuously stirring a resulting mixture. The resulting mixture can be stirred by hand or with the aid of an electrical mixing device, such as, e.g., a motorized stirrer. In some cases, mixing can continue until the PAA has been fully mixed in the mixture and stirring becomes more difficult. This can occur due to an increase in viscosity of the mixture of PAA and PTMEG. In some cases, an increase in viscosity of the mixture accompanies a hydrogelation process upon mixing PAA and a polyglycol, such as, e.g., PTMEG.

In another embodiment, a hydrogel may be formed by mixing PAA with a polyglycol and stirring the mixture for a time period between about 5 minutes and 40 minutes, or between about 10 minutes and 30 minutes, or between about 15 minutes and 20 minutes. In another embodiment, a hydrogel is formed by mixing PAA with PTMEG (also “PTMG” herein) and stirring the mixture for a time period between about 5 minutes and 40 minutes, or between about 10 minutes and 30 minutes, or between about 15 minutes and 20 minutes.

In another embodiment, a hydrogel may be formed by mixing a first polymeric material, second polymeric material and third material at a temperature between about 15° C. and 30° C. and heating the mixture up to a temperature between about 50° C. and 100° C., or between about 55° C. and 70° C., or between about 58° C. and 62° C. In some cases, a hydrogel is formed by mixing a first polymeric material, a second polymeric material and a third material at a temperature between about 15° C. and 30° C. and heating the mixture up to a temperature of about 55° C., or 56° C., or 57° C., or 58° C., or 59° C., or 60° C., or 61° C., or 62° C., or 63° C., or 64° C., or 65° C. The first polymeric material can include PAA, the second polymeric material can include PTMEG, and the third material can include acrylamide (AAm). In an embodiment, forming the mixture at a temperature between about 15° C. and 30° C. induces the formation of hydrogen bonds between the first polymeric material (e.g., PAA) and the second polymeric material (e.g., PTMEG).

In a further embodiment, a hydrogel may be formed by mixing a first polymeric material, second polymeric material and a material having a vinyl functionality at a temperature between about 15° C. and 30° C. and heating the mixture up to a temperature of about 55° C., or 55° C., or 57° C., or 58° C., or 59° C., or 60° C., or 61° C., or 62° C., or 63° C., or 64° C., or 65° C. The first polymeric material can include PAA, the second polymeric material can include PTMEG, and the monomer can include a material having acrylamide (AAm). In some examples, a material having a vinyl functionality (also referred to as “vinyl-containing material” herein) is acrylic acid, methylacrylic acid, vinyl alcohol, vinyl acetate, butyl acrylate, vinyl acrylate, vinylbenzoic acid, vinylbenzyl alcohol, vinylboronic acid dibutyl ester, vinylformamide, vinyl methacrylate, vinylpyridine, 1-vinyl-2-pyrrolidone, vinylsulfonic acid and vinyltrimethoxysilane. In some embodiments, a material having a vinyl functionality can be a vinyl-containing polymer (also referred to as “vinyl-containing material” herein). When a vinyl-containing monomer or polymer is an acid, a hydrogel may comprise a salt derivative of the acid. For example, when the monomer is acrylic acid, a hydrogel may comprise a sodium or potassium alt of acrylic acid, or a sodium or potassium salt of polyacrylic acid. In some embodiments, the vinyl-containing material is covalently bonded to polyacrylic acid.

In yet another embodiment, a hydrogel may be formed by combining a first polymeric material and second polymeric material, wherein one or more of the first and second polymeric materials have one or more hydrophilic moieties (or subgroups). In an embodiment, the second polymeric material can include —O—(CH₂)ₙ subunits, wherein ‘n’ is a number greater than or equal to 1, or 2, or 3, or 4, or 5, or 6, or 7, or 8, or 9, or 10, or 11, or 12, or 13, or 14, or 15, or 16, or 17, or 18, or 19, or 20. In another embodiment, the second polymeric material can include —O—(CH₂CH₂)ₘ subunits, wherein ‘m’ is a number greater than or equal to 1, or 2, or 3, or 4, or 5, or 6, or 7, or 8, or 9, or 10, or 11, or 12, or 13, or 14, or 15, or 16, or 17, or 18, or 19, or 20 (see above). One or more of the first and second polymeric materials can be joined together through hydrogen bonding interactions between the first and second polymeric materials, between the first polymeric material or second polymeric material, or both. In an embodiment, the first and third polymeric materials can be joined by hydrogen bonding interactions. In another embodiment, the first polymeric material can be hydrogen-bonded to another first polymeric material. In another embodiment, one or more of the first and second polymeric materials can be joined together through cross-linkages (or cross-linking interactions), such as ionic or covalent bonds. In an embodiment, the first polymeric material is PAA or a salt or derivative of PAA and the second polymeric material is a polyglycol (e.g., PTMEG or a salt or derivative of PTMEG). In another embodiment, the first polymeric material is PAA or a salt or derivative of PAA and the second polymeric material is PTMEG or a salt or derivative of PTMEG. In another embodiment, the first polymeric material is PAA or a salt or derivative of PAA, and the second polymeric material is PAM or a salt or derivative of PAM. In another embodiment, the first polymeric material is a polyglycol (e.g., PTMEG or a salt or derivative of PTMEG), and the second polymeric material is PAM or a salt or derivative of PAM. In another embodiment, the first polymeric material is PTMEG or a salt or derivative of PTMEG, and the second polymeric material is PAM or a salt or derivative of PAM.

In one embodiment, a hydrogel may be formed by combining a first polymeric material, second polymeric material, and third polymeric material, wherein one or more of the first, second and third polymeric materials have one or more hydrophilic moieties (or subgroups). In an embodiment, the first polymeric material can include PAA. The second polymeric material can include —O—(CH₂)ₙ subunits, wherein ‘n’ is a number greater than or equal to 1, or 2, or 3, or 4, or 5, or 6, or 7, or 8, or 9, or 10, or 11, or 12, or 13, or 14, or 15, or 16, or 17, or 18, or 19, or 20. In some cases, ‘n’ is a number greater than or equal to 3, or greater than or equal to 4, or greater than or equal to 5. The second polymeric material may include —O—(CH₂CH₂)ₘ subunits, wherein ‘m’ is a number greater than or equal to 1, or 2, or 3, or 4, or 5, or 6, or 7, or 8, or 9, or 10, or 11, or 12, or 13, or 14, or 15, or 16, or 17, or 18, or 19, or 20 (see above). In some cases, ‘m’ is a number greater than or equal to 2, or greater than or equal to 3, or greater than or equal to 4. Two or more of the first, second and third polymeric materials can be joined together through hydrogen bonding interactions. In an example, the first and third polymeric materials can be joined by hydrogen bonding interactions. In another example, the first and second polymeric materials can be joined by hydrogen bonding interactions. In another example, the second and third polymeric materials can be joined by hydrogen bonding interactions. In another example, the first, second and third polymeric materials can be joined by hydrogen bonding interactions. In another example, the first, second or third polymeric material can be hydrogen-bonded to another first, second or third polymeric material, respectively. In another example, one or more of the first, second and third polymeric materials can be joined together through cross-linkages (or cross-linking interactions), such as ionic or covalent bonds. In an embodiment, the first polymeric material is PAA or a salt or derivative of PAA such as a potassium salt of PAA, the second polymeric material is a polyglycol (e.g., PTMEG or a salt or derivative of PTMEG), and the third polymeric material is PAM or a salt or derivative of PAM. In another embodiment, the first polymeric material is PAA or a salt or derivative of PAA, the second polymeric material is PTMEG or a salt or derivative of PTMEG, and the third polymeric material is PAM or a salt or derivative of PAM.

In another embodiment, a hydrogel may be formed by combining PAA, PTMEG (or PEG) and PAM to form a mixture (or blend). In an embodiment, the mixture is heated during preparing the mixture, after forming the mixture, or both. In some cases, the mixture is not heated. In other cases, the mixture is prepared at a temperature between about 10° C. and 100° C., or between about 15° C. and 80° C., or 20° C. and 50° C.

Exemplary non-toxic and biodegradable hydrogels can be prepared by using acrylic acid plus environmentally-friendly polymers. Such non-toxic and biodegradable hydrogels can be friendly to the environment (also referred to as “environmentally-friendly hydrogels” herein), as they minimize, if not eliminate, the production of hazardous components, thereby minimizing, if not eliminating, the risk of hazardous components from entering (or leaching into) water supplies, for example.

Additionally, an exemplary hydrogel can be formed by combining hydrogels as formed by methods described herein with an environmentally-friendly polymer, such as a polymer occurring in nature, including polymers that can be extracted from substances occurring naturally in nature. Natural polymers can include one or more of a cellulose (e.g., carboxymethyl cellulose), hydrogelatin and clay. In another embodiment, a hydrogel can be formed by combining PAA, a polyglycol (e.g., PTMEG) and one or more natural polymers in place of an acrylamide-containing polymer (e.g., PAM). In another embodiment, a hydrogel can be formed by combining PAA, a polyglycol (e.g., PTMEG), an acrylamide-containing polymer (e.g., PAM), and one or more natural polymers, such as one or more of a cellulose or cellulose-containing material (e.g., carboxymethyl cellulose), clay and hydrogelatin. In an embodiment, a natural polymer can include a cellulose or a derivative or a cellulose, such as carboxymethyl cellulose. In another embodiment, a natural polymer can include clay. In another embodiment, a natural polymer can include hydrogelatin. In another embodiment, a natural polymer can include one or more of a cellulose, clay and hydrogelatin. In some embodiments, a natural polymer can include any substance that does not decompose under ambient conditions or is configured to decompose into a substance that is not unfriendly to the environment, or not otherwise hazardous (e.g., not toxic to animals) In an embodiment, a hydrogel is formed by combining PAA, a polyglycol (e.g., PTMEG) and one or more environmentally-friendly polymers or subunits (including monomers) of the one or more environmentally-friendly polymers.

In one embodiment, a hydrogel can be formed by combining PAA, PTMEG and a cellulose, such as, e.g., carboxymethyl cellulose. In another embodiment, a hydrogel can be formed by combining PAA, PTMEG and hydrogelatin. In another embodiment, a hydrogel can be formed by combining PAA, PTMEG and clay. In another embodiment, a hydrogel can be formed by combining PAA, PTMEG and one or more of a cellulose (e.g., carboxymethyl cellulose), hydrogelatin and clay.

In various exemplary hydrogels or hydrogels, a polyglycol may be present. A polyglycol may be an environmentally friendly polyglycol, such as PTMEG. The environmentally friendly polyglycol can be combined with, for example, PAA to form an environmentally friendly hydrogel.

In another embodiment, a hydrogel may be provided comprising PAA, a polyglycol, and polyvinyl alcohol (PVA). PVA can be used in place of an acrylamide-containing polymer (e.g., PAM). In some cases, a hydrogel is provided comprising PAA, a polyglycol (e.g., PTMEG), PVA, clay and a cellulose (e.g., carboxylmethyl cellulose). In such cases, PAA can be hydrogen-bonded to the polyglycol, as described above.

In some examples, a hydrogel can be formed by combining PAA, a polyglycol (e.g., PTMEG) and acrylamide monomers to form a mixture, and heating the mixture to form the hydrogel. In such a case, heating the mixture causes the acrylamide monomers to polymerize. In other examples, a hydrogel can be formed by combining PAA, a polyglycol (e.g., PTMEG) and an environmentally-friend polymer or polymer subunit (or monomer) to form a mixture, and heating the mixture. In some cases, heating the mixture polymerizes natural or environmentally-friendly polymer subunits (or monomers).

### Hydrogel Properties

Hydrogels used in embodiments of the present invention can have material properties, such as glass transition temperature, viscosity, hardness, conductivity, and tensile strength, suited to various uses and applications, such as agricultural applications or purposes.

In one embodiment, a hydrogel having PAA and a polyglycol may have a rubber-like texture (soft or tough rubber) at a temperature between about 10° C. and 40° C., or 15° C. and 30° C. In some cases, mixing PAA and PTMEG produces a hydrogel or hydrogel having properties that can be different from the properties of the PAA and PTMEG components. In another embodiment, a hydrogel formed from PAA and PTMEG does not exhibit a crystal structure; it can be amorphous.

In another embodiment, a hydrogel formed of PAA and a polyglycol may have a compressive strength of at least about 100 g/cm², or at least about 500 g/cm², or at least about 1,000 g/cm², or at least about 2,000 g/cm², or at least about 3,000 g/cm², or at least about 4,000 g/cm², or at least about 5,000 g/cm², or at least about 6,000 g/cm², or at least about 7,000 g/cm², or at least about 8,000 g/cm², or at least about 9,000 g/cm², or at least about 10,000 g/cm², or at least about 15,000 g/cm², or at least about 20,000 g/cm², or at least about 40,000 g/cm², or at least about 100,000 g/cm², or at least about 200,000 g/cm². In some cases, a hydrogel or hydrogel formed of PAA and PTMEG can have a compressive strength of at least about 100 g/cm², or at least about 500 g/cm², or at least about 1,000 g/cm², or at least about 2,000 g/cm², or at least about 3,000 g/cm², or at least about 4,000 g/cm², or at least about 5,000 g/cm², or at least about 6,000 g/cm², or at least about 7,000 g/cm², or at least about 8,000 g/cm², or at least about 9,000 g/cm², or at least about 10,000 g/cm². In some cases, a hydrogel or hydrogel formed of PAA and a polyglycol can have a compressive strength of at least about 1,000 g/cm², or 2,000 g/cm², or 3,000 g/cm², or 4,000 g/cm², or 5,000 g/cm², or 6,000 g/cm², or 7,000 g/cm², or 8,000 g/cm² without failure. Compressive strength can be assessed based on stress-strain measurements. In some cases, a hydrogel or hydrogel formed of PAA and a polyglycol has a compressive strength between about 100 g/cm² and 9,000 g/cm². In some cases, a hydrogel or hydrogel formed of PAA and PTMEG has a compressive strength between about 100 g/cm² and 9,000 g/cm².

In a further embodiment, a hydrogel formed of PAA and a polyglycol may have a tensile strength of at least about 100 g/cm², or at least about 500 g/cm², or at least about 1,000 g/cm², or at least about 2,000 g/cm², or at least about 3,000 g/cm², or at least about 4,000 g/cm², or at least about 5,000 g/cm², or at least about 6,000 g/cm², or at least about 7,000 g/cm², or at least about 8,000 g/cm², or at least about 9,000 g/cm², or at least about 10,000 g/cm², or at least about 15,000 g/cm², or at least about 20,000 g/cm², or at least about 40,000 g/cm², or at least about 100,000 g/cm², or at least about 200,000 g/cm². In some cases, a hydrogel or hydrogel formed of PAA and PTMEG has a tensile strength of at least about 100 g/cm², or at least about 500 g/cm², or at least about 1,000 g/cm², or at least about 2,000 g/cm², or at least about 3,000 g/cm², or at least about 4,000 g/cm², or at least about 5,000 g/cm², or at least about 6,000 g/cm², or at least about 7,000 g/cm², or at least about 8,000 g/cm², or at least about 9,000 g/cm², or at least about 10,000 g/cm². In some cases, a hydrogel or hydrogel formed of PAA and a polyglycol has a tensile strength of at least about 1,000 g/cm², or 2,000 g/cm², or 3,000 g/cm², or 4,000 g/cm², or 5,000 g/cm², or 6,000 g/cm², or 7,000 g/cm², or 8,000 g/cm² without failure. Tensile strength can be assessed based on stress-strain measurements. In some cases, a hydrogel or hydrogel formed of PAA and a polyglycol has a tensile strength between about 100 g/cm² and 9,000 g/cm². In some cases, a hydrogel or hydrogel formed of PAA and PTMEG has a tensile strength between about 100 g/cm² and 9,000 g/cm².

In some embodiments, over sufficiently long periods of time, a strengthening of the polymeric hydrogel can be detected. This aging process can lead to stress-strain curves in compression that parallel the original stress-strain curve, but displaced slightly higher (and growing higher with time).

In one embodiment, a hydrogel having PAA and a polyglycol can comprise hydrogen bonds between the PAA and polyglycol. In some cases, a hydrogel having PAA and a polyglycol comprises covalent bonds between the PAA and polyglycol. In other cases, a hydrogel or hydrogel having PAA and a polyglycol comprises ionic bonds between the PAA and polyglycol. A hydrogel or hydrogel having PAA and a polyglycol can comprise one or more of hydrogen, covalent and ionic bonds between the PAA and polyglycol.

A hydrogel having PAA and PTMEG may comprise hydrogen bonds between the PAA and PTMEG. In some cases, a hydrogel or hydrogel having PAA and PTMEG comprises covalent bonds between the PAA and PTMEG. In other cases, a hydrogel or hydrogel having PAA and PTMEG comprises ionic bonds between the PAA and PTMEG. A hydrogel or hydrogel having PAA and PTMEG may comprise one or more of hydrogen, covalent and ionic bonds between the PAA and PTMEG.

In another embodiment, a hydrogel comprising PAA and a polyglycol may include a three-dimensional network of hydrogen bonds between the PAA and polyglycol. In another embodiment, a hydrogel or hydrogel comprising PAA and PTMEG includes a three-dimensional network of hydrogen bonds between the PAA and PTMEG.

According to one aspect of the invention, a hydrogel may have a water absorbency (or water retention capacity) of at least about 10%, or 20%, or 30%, or 40%, or 50%, or 60%, or 70%, or 80%, or 90%, or 100%, or 150%, or 200%, or 250%, or 300%, or 350%, or 400%, or 450%, or 500%, or 550%, or 600%, or 650%, or 700%, or 750%, or 800%, or 850%, or 900%, or 950%, or 1000%, or more the weight of the hydrogel. In some cases, a hydrogel comprising PAA and PTMEG is provided having a water absorbency (or water retention capacity) of at least about 10%, or 20%, or 30%, or 40%, or 50%, or 60%, or 70%, or 80%, or 90%, or 100%, or 150%, or 200%, or 250%, or 300%, or 350%, or 400%, or 450%, or 500%, or 550%, or 600%, or 650%, or 700%, or 750%, or 800%, or 850%, or 900%, or 950%, or 1000%, or more the weight of the hydrogel. In some cases, a hydrogel comprising PAA, PTMEG and polyacrylamide (“PAM”) is provided having a water absorbency (or water retention capacity) of at least about 10%, or 20%, or 30%, or 40%, or 50%, or 60%, or 70%, or 80%, or 90%, or 100%, or 150%, or 200%, or 250%, or 300%, or 350%, or 400%, or 450%, or 500%, or 550%, or 600%, or 650%, or 700%, or 750%, or 800%, or 850%, or 900%, or 950%, or 1000%, or more the weight of the hydrogel.

According to another aspect of the invention, a hydrogel may have a water absorbency (or water retention capacity) of up to about 10%, or 20%, or 30%, or 40%, or 50%, or 60%, or 70%, or 80%, or 90%, or 100%, or 150%, or 200%, or 250%, or 300%, or 350%, or 400%, or 450%, or 500%, or 550%, or 600%, or 650%, or 700%, or 750%, or 800%, or 850%, or 900%, or 950%, or 1000%, or more the weight of the hydrogel. In some cases, a hydrogel comprising PAA and PTMEG is provided having a water absorbency (or water retention capacity) of up to about 10%, or 20%, or 30%, or 40%, or 50%, or 60%, or 70%, or 80%, or 90%, or 100%, or 150%, or 200%, or 250%, or 300%, or 350%, or 400%, or 450%, or 500%, or 550%, or 600%, or 650%, or 700%, or 750%, or 800%, or 850%, or 900%, or 950%, or 1000%, or more the weight of the hydrogel. In some cases, a hydrogel comprising PAA, PTMEG and polyacrylamide (“PAM”) is provided having a water absorbency (or water retention capacity) of up to about 10%, or 20%, or 30%, or 40%, or 50%, or 60%, or 70%, or 80%, or 90%, or 100%, or 150%, or 200%, or 250%, or 300%, or 350%, or 400%, or 450%, or 500%, or 550%, or 600%, or 650%, or 700%, or 750%, or 800%, or 850%, or 900%, or 950%, or 1000%, or more the weight of the hydrogel.

According to a further aspect of the invention, a hydrogel may have a water absorbency (or water retention capacity) up to about 10 times, or 20 times, or 30 times, or 40 times, or 50 times, or 60 times, or 70 times, or 80 times, or 90 times, or 100 times, or 200 times, or 300 times, or 400 times, or 500 times, or 600 times, or 700 times, or 800 times, or 900 times, or 1000 times, or 2000 times, or 3000 times, or 4000 times, or 5000 times, or 6000 times, or 7000 times, or 8000 times, or 9000 times, or 10,000 times, or 20,000 times, or 40,000 times, or 80,000 times, or 100,000 times, or more the weight of the hydrogel. In another embodiment, a hydrogel comprising PAA and PTMEG is provided having a water absorbency (or water retention capacity) up to about 10 times, or 20 times, or 30 times, or 40 times, or 50 times, or 60 times, or 70 times, or 80 times, or 90 times, or 100 times, or 200 times, or 300 times, or 400 times, or 500 times, or 600 times, or 700 times, or 800 times, or 900 times, or 1000 times, or 2000 times, or 3000 times, or 4000 times, or 5000 times, or 6000 times, or 7000 times, or 8000 times, or 9000 times, or 10,000 times, or 20,000 times, or 40,000 times, or 80,000 times, or 100,000 times, or more the weight of the hydrogel. In another embodiment, a hydrogel comprising PAA, PTMEG and polyacrylamide (“PAM”) is provided having a water absorbency (or water retention capacity) up to about 10 times, or 20 times, or 30 times, or 40 times, or 50 times, or 60 times, or 70 times, or 80 times, or 90 times, or 100 times, or 200 times, or 300 times, or 400 times, or 500 times, or 600 times, or 700 times, or 800 times, or 900 times, or 1000 times, or 2000 times, or 3000 times, or 4000 times, or 5000 times, or 6000 times, or 7000 times, or 8000 times, or 9000 times, or 10,000 times, or 20,000 times, or 40,000 times, or 80,000 times, or 100,000 times, or more the weight of the hydrogel.

In one embodiment, a hydrogel may remain substantially unchanged after at least 1, or 2, or 3, or 4, or 5, or 6, or 7, or 8, or 9, or 10, or 11, or 12, or 13, or 14, or 15, or 16, or 17, or 18, or 19, or 20, or 21, or 22, or 23, or 24, or 25, or 26, or 27, or 28, or 29, or 30, or 31, or 32, or 33, or 34, or 35, or 36, or 37, or 38, or 39, or 40, or 41, or 42, or 43, or 44, or 45, or 46, or 47, or 48, or 49, or 50, or 70, or 80, or 90, or 100, or more hydration-dehydration cycles.

Hydrogels provided according to various embodiments herein can be formed into various shapes, such as a shape with a spherical, triangular, square, rectangular, pentagonal, hexagonal, or octagonal cross section. In some cases, hydrogels or hydrogels can be shaped using molds (or templates) with the desired shape. Hydrogels can be shaped into forms that have sizes (e.g., diameters) of at least about 100 nanometers (nm), or 500 nm, or 1 micrometer (μm), or 100 μm, or 500 μm, or 1 mm, or 10 mm, or 50 mm, or 1 cm, or 50 cm, or 1 m, or 5 m, or 10 m, or 100 m, or more.

### Soil Erosion

According to one embodiment of the present invention, gels and/or hydrogels according to embodiments of the disclosure can aid to reduce top soil erosion. In some cases, a gel (including for example a hydrogel) applied to a top soil of a plot of soil or land can reduce top soil erosion by at least 1%, 2%, 3%, 4%, 5%, 10%, 20%, 30%, 40%, 50%, 60%, 70%, 80%, or 90%. Such reduction can be in relation to situations in which the gel is not applied to a plot of soil.

According to one aspect, average annual soil loss for a given plot of soil may be defined as follows: A=R*K*L*S*C*P, wherein where R is rainfall erosivity factor, K is soil erodibility factor, L and S are topographic factors representing length and slope, and C and P are cropping management factors. In some examples, a gel applied to a top surface of a plot of soil can reduce average annual soil loss by at least 1%, 2%, 3%, 4%, 5%, 10%, 20%, 30%, 40%, 50%, 60%, 70%, 80%, 90%, or 95%. Such reduction can be in relation to situations in which the gel is not applied to a plot of soil.

According to another aspect, gels (including for example hydrogels) according to embodiments of the disclosure can reduce, if not minimize, instances in which wind or other environmental factors remove soil (e.g., minerals) from a first location and direct the soil to a second location. In some cases, a gel (e.g., hydrogel), as described herein, can reduce the likelihood of soil being removed from the first location by at least about 1%, 2%, 3%, 4%, 5%, 10%, 20%, 30%, 40%, 50%, 60%, 70%, 80%, 90%, or 95%.

### Example 1

According to one embodiment, a hydrogel is formed by mixing 11.5 g of PAA (M_{w} of about 400,000 g/mol) and 37.0 g of PTMEG (M_{w} of about 650 g/mol) and stirring the solids together, without solvent, at room temperature for about 24 hours. PAA and PTMEG were obtained from Aldrich Chemical Co. Fourier Transfer Infrared (also “FTIR” and “IR” herein) spectra of the hydrogel are indicative of the presence of hydrogen bonding in the hydrogel. In addition, the IR spectra show change with time due to the aging properties of the hydrogel. The hydrogel is resistive to attack (i.e., corrosion, decomposition) by organic solvents (e.g., acetone), strong bases (e.g., NaOH) and strong acids (e.g., H₂SO₄); the hydrogel retains its properties (e.g., viscosity, strength) when exposed to organic solvents, strong bases and strong acids (both separate trials in acid and base and trials of hydrogels exposed to acids and bases in succession).

### Example 2

According to another embodiment, 15.0 g of PAA powder (M_{w} of about 400,000 g/mol) is mixed with 15.0 g of PTMEG (M_{w} of about 650 g/mol) at a temperature of about 25° C. PAA and PTMEG are obtained from Aldrich Chemical Co. The mixing is continually processed until a uniform rubber-like and near transparent solid is formed. The shape of this hydrogel material can selected by using molds or templates with shapes as desired.

### Example 3

According to a further embodiment, a hydrophilic hydrogel is produced by combining PAA and PTMEG polymers under normal hydrophilic monomer polymerization conditions (i.e., with the aid of a catalyst and a cross linker, and heating).

In a particular embodiment, a hydrogel is prepared by the methods described herein. 11.2 g of poly(acrylic acid) (M_{w} of about 400,000 g/mol), 50 g of PTMEG and 200 g of potato starch are dispersed into 2000 ml of water. Under stirring, 167 g of acrylic acid, 100 g of acrylamide, 3 g of N,N′-methylene bis(acrylamide) with 6 g of potassium persulfate are added into the above solution. The stirring is continued for about 20 minutes and 1 ml of tetramethylethylenediamine is added. Then the reactor is heated to 60° C. until a hydrogel is formed. The hydrogel formed is washed by water and cut into 1-1.5 cm³ portions. The water absorbency of the dried hydrogel is about 400 g of H₂O/g hydrogel.

### Example 4

In another embodiment, 5 g of poly(acrylic acid) (M_{w} of about 400,000 g/mol), 22.3 g of PTMEG and 200 g of potato starch are dispersed into 2000 ml of water. Under stirring, 200 g of acrylic acid, 80 g of acrylamide, 1 g of N,N′-methylene bis(acrylamide) with 6 g of potassium persulfate are added into the above solution. The stirring is continued for about 20 minutes and 1 ml of tetramethylethylenediamine is added. Then the reactor is heated to 60° C. until the hydrogel is formed. The hydrogel formed is washed by water and cut into 1-1.5 cm³ species. The water absorbency of dried hydrogel is about 400 g of H₂O/g of hydrogel.

### Example 5

In a further embodiment, hydrogels are formed by combining PAA, PTMEG, Acrylamide (AAm) and a cross-linker in water. A cross linker can be di(ethyleneglycol) divinyl ether, di(ethylglycol) diacrylate and N,N′-methylene bis(acrylamide). The hydrogels are prepared with the aid of the following: NaOH (aq) (7.380 g of NaOH dissolved into 200 ml of water) and, acrylamide (AAm), and a cross-linker. Polymerization is processed at 60° C. for 3-4 hours. The strengths of the hydrogels are assessed, as shown in the following table:

| | | | | Water | | | | |
|---|---|---|---|---|---|---|---|---|
| | | | | (For | | | Water | |
| | | | | further | | Cross- | (for | Strength |
| | | | | NaOH | AAm | linker | reaction | Test |
| Lot | PAA (g) | PTMEG (g) | NaOH | dilution) | (g) | (mol %) | mixture) | (g/cm²) |
| 0207A | 1.15 | 1.15 | 10 ml | 90 ml | 6.0 | 3% | 100 ml | 941 g/cm² |
| | | | (~0.5 mol | | | 0.18 g | | |
| | | | of | | | | | |
| | | | PAA) | | | | | |
| 0220 | 1.15 | 1.15 | 10 ml | 70 ml | 6.0 | 3% | 70 ml | 920 g/cm² |
| | | | (~0.5 mol | | | 0.18 g | | |
| | | | of | | | | | |
| | | | PAA) | | | | | |
| 0222 | 1.15 | 1.15 | 10 ml | 50 ml | 6.0 | 3% | 40 ml | 910 g/cm² |
| | | | (~0.5 mol | | | 0.18 g | | |
| | | | of | | | | | |
| | | | PAA) | | | | | |
| 0314A | 0.25 | 0.25 | 2 ml | 58 ml | 6.0 | 3% | 40 ml | 2460 g/cm² |
| | | | (~0.5 mol | | | 0.18 g | | |
| | | | of | | | | | |
| | | | PAA) | | | | | |
| 0314B | 0.25 | 0.25 | 2 ml | 28 ml | 6.0 | 3% | 20 ml | 1600 g/cm² |
| | | | (~0.5 mol | | | 0.18 g | | |
| | | | of | | | | | |
| | | | PAA) | | | | | |

### Example 6

According to another embodiment, 15 g of carboxymethyl cellulose is dissolved into 2000 mL of water and then added into a 5 L reactor under stirring. The solution is continually stirred and 5 g of potassium persulfate, 200 g of acrylic acid, 1 g of ethylene dimethyl acrylate and 11 g of poly(acrylic acid) (M_{w} of about 400,000 g/mol) is added. The reactor is heated at about 60° C., and 22 g of PTMEG (polytetramethylene ether glycol, M_{w} of about 650 g/mol) is added into the reactor. The mixture is stirred for about another hour until polymerization is completed. The hydrogel formed above is removed from the reactor and cut into small pieces of about 1-1.5 cm³. Its water-absorbency is tested.

### Example 7

In a further embodiment, 20 g of gelatin is dissolved into 2000 mL of water and then added into a 5 L reactor under stirring. The solution is continually stirred and 5 g of potassium persulfate, 200 g of acrylic acid, 0.5 g of ethylene dimethyl acrylate and 10 g of poly(acrylic acid) (M_{w} of about 400,000 g/mol) is added. The reactor is heated at about 60° C., and 20 g of PTMEG (polytetramethylene ether glycol, M_{w} of about 650 g/mol) is added into the reactor. The mixture is stirred for about another 1 hour until polymerization is completed. The hydrogel formed above is removed from the reactor and cut into small pieces of about 1-1.5 cm³. Its water-absorbency is tested.

### Example 8

According to one aspect, a hydrogel is prepared by the method discussed in Example 7 above, but polyvinyl alcohol (PVA) is used instead of gelatin.

### Example 9

According to a further aspect, a hydrogel is prepared by the method discussed in Example 7 above, but PVA, clay and carboxylmethyl cellulose are used instead of gelatin.

### Example 10

In an embodiment of the invention, 100 g of acrylic acid is dissolved into 300 g of water (Solution A). Then, 54 g of potassium hydroxide is dissolved into Solution A under cooling. The mixture is placed into a 2 L round bottom flask equipped mechanical mixer, temperature controller and heating mantle. Then, 0.3 g of N,N′-methylene bis(acrylamide) and 1.5 g of potassium persulfate are added. Also, 10 g of polyacrylic acid and 20 g of PTMEG are added into the 22 L round bottom flask under stirring. The polymerization reaction is conducted at a temperature of 65° C. for about two hours.

### Example 11

According to one embodiment, 3 kg of acrylic acid is dissolved into 4.5 L of water (Solution A). Then, 1620 g of potassium hydroxide are dissolved into 4.5 L of cold water (Solution B). Solution A and Solution are mixed under stirring. The mixture is placed into a 22 L round bottom flask equipped mechanical mixer, temperature controller and heating mantle. Then, 9.0 g of N,N′-methylene bis(acrylamide) and 45 g of potassium persulfate are added. Also, 30 g of polyacrylic acid and 60 g of PTMG were added into the 22 L round bottom flask under stirring. The polymerization reaction is conducted at a temperature of 50-55° C. for about three hours. The bulk hydrogel product is cut using a grinder and then dried at 70° C. Its absorbency of tap water is 200-250 times its dry weight.

### Example 12

According to another embodiment, a hydrogel is prepared as described above in Example 11, but only 1167 g of potassium hydroxide is used to form the hydrogel.

### Example 13

According to a further embodiment, 3 kg of acrylic acid is dissolved into 4.5 L of water (Solution A). And, 1.16 kg of Miracle-Gro® Plant Food 24-8-16 is dissolved into 4.5 L of cold water (Solution B). Solution A and Solution are mixed under stirring. The mixture is placed into a 22 L round bottom flask equipped mechanical mixer, temperature controller and heating mantle. Then, 9.0 g of N,N′-methylene bis(acrylamide) and 45 g of potassium persulfate are added. Also, 30 g of polyacrylic acid and 60 g of PTMEG are added into the 22 L flask under stirring. The polymerization reaction is conducted at a temperature of 50-55° C. for about three hours. The bulk product is cut using a grinder.

### Example 14

According to an embodiment, 3 kg of acrylic acid is dissolved into 4.5 L of water (Solution A). Then, 1167 g of potassium hydroxide and 973.7 g of 30% ammonium hydroxide aqueous are dissolved into 4.5 L of cold water (Solution B). Solution A and Solution are mixed under stirring. The mixture is placed into a 22 L round bottom flask equipped mechanical mixer, temperature controller and heating mantle. Then, 9.0 g of N,N′-methylene bis(acrylamide) and 45 g of potassium persulfate are added. Also, 30 g of polyacrylic acid and 60 g of PTMG are added into the 22 L flask under stirring. The polymerization reaction is conducted at a temperature of 50-55° C. for about three hours to form a hydrogel.

### Example 15

In one embodiment of the invention, hydration and dehydration cycle tests of a hydrogel are performed. The hydration and dehydration cycle tests are conducted in a beaker. The weight of beaker is 51.00 g. 0.29 g of dried PAA-PTMEG hydrogel is used for this test. For each hydration testing, 80 ml of water is added into the beaker and the water is fully absorbed into the hydrogel for about 5 hours at room temperature. The un-absorbed water is then removed. Then, the weight of beaker plus the wetted hydrogel is recorded. The dehydration temperature is kept at about 80° C. overnight and the weight of dried hydrogel plus the beaker is then recorded. This hydration and dehydration are continuously repeated for 18 days. The results of this study are summarized in the table below, pointing to the lack of change in the weight of the hydrogel over a number of hydration-dehydration cycles.

| | The weight of | The weight of |
|---|---|---|
| | beaker + hydrogel + | beaker + hydrogel |
| Days | water absorbed | after drying (g) |
| 1 | 98.32 g | 51.29 |
| 2 | 99.31 g | 51.30 |
| 3 | 99.00 g | 51.30 |
| 4 | 99.50 g | 51.29 |
| 5 | 99.90 g | 51.31 |
| 6 | 99.78 g | 51.28 |
| 7 | 100.00 g | 51.29 |
| 8 | 100.00 g | 51.30 |
| 9 | 103.62 g | 51.26 |
| 10 | 101.55 g | 51.27 |
| 11 | 100.00 g | 51.27 |
| 12 | 102.40 g | 51.26 |
| 13 | 100.00 g | 51.27 |
| 14 | 100.50 g | 51.26 |
| 15 | 103.30 g | 51.25 |
| 16 | 103.62 g | 51.26 |
| 17 | 100.00 g | 51.25 |
| 18 | 99.80 g | 51.25 |

### Example 16

In another embodiment of the present invention, a hydrogel comprising a potassium salt of polyacrylic acid crosslinked with such as PTMG is added to irrigation water for flood irrigation on a series of plots of land for experimentally determining the effect of the application of the hydrogel to the rate of soil erosion on the plots. An experimental area totaling approximately 15 acres, made up of 9 substantially equal adjoining plots of land each of approximately 60′×1200′ (1.65 acres) size were used to test 3 replicates each of 3 different hydrogel application rates (0 ppm hydrogel, 5 ppm hydrogel and 10 ppm hydrogel in irrigation water) to the native Rositas fine sand type soil present in the soil plots. The experimental soil plots were laid out approximately as shown in the table below:

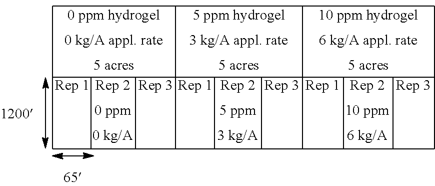

Each plot of soil is flood irrigated by a 6″ irrigation flood (½ of an acre/ft or approximately 617 cubic meters water per acre). The hydrogel is applied by mixing into the irrigation water at the 0 ppm, 5 ppm and 10 ppm hydrogel application rates using the above-described hydrogel in powdered form with particle size of less than 600 um. Using the 0 ppm, 5 ppm, and 10 ppm hydrogel application rates applied by a 6″ deep irrigation flood (617,000 kg of water per Acre) corresponds to the approximate mass/Acre hydrogel application rates shown in the table below:

| 0 ppm hydrogel | 5 ppm hydrogel | 10 ppm hydrogel |
|---|---|---|
| 0 kg/A | 3 kg/A | 6 kg/A |

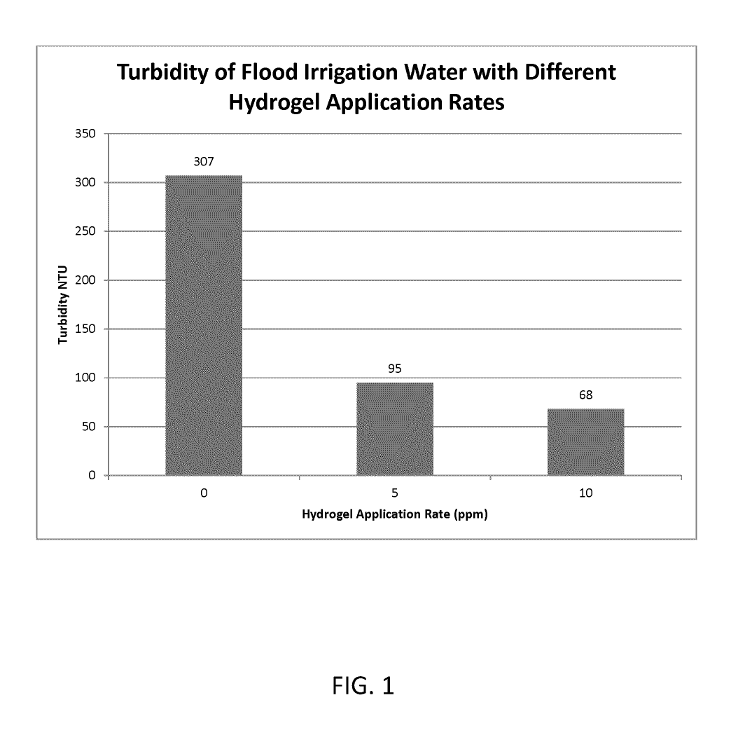

Following mixing of the hydrogel into the irrigation water and flood irrigation of each of the 9 soil plots, four samples of irrigation runoff water are collected at one end of each soil plot. The turbidity of each irrigation water sample is then tested using a nephelometer, to determine the turbidity of the irrigation runoff water resulting from the entrainment of eroded soil particles in the irrigation water as a result of soil erosion in each plot. FIG. 1 illustrates a graph showing average irrigation runoff water turbidity level measurements for each of control, 5 ppm and 10 ppm hydrogel treatment levels. The results of the irrigation runoff turbidity measurements for each sample and each plot are shown in the table below in nephelometric turbidity units (NTU):

| | | Turbidity Measurement (NTU) | | |
|---|---|---|---|---|
| Soil Plots | | Control | | |
| Rep | Sample | (0 ppm) | 5 ppm | 10 ppm |
| 1 | 1 | 357 | 86 | 33 |
| 1 | 2 | 424 | 115 | 32 |
| 1 | 3 | 383 | 31 | 66 |
| 1 | 4 | 429 | 23 | 25 |
| 2 | 1 | 148 | 76 | 76 |
| 2 | 2 | 201 | 82 | 82 |
| 2 | 3 | 298 | 87 | 87 |
| 2 | 4 | 286 | 65 | 65 |
| 3 | 1 | 552 | 151 | 97 |
| 3 | 2 | 262 | 148 | 85 |
| 3 | 3 | 189 | 147 | 86 |
| 3 | 4 | 152 | 129 | 87 |

| | | | |
|---|---|---|---|
| Average | 307 | 95 | 68 |
| SD | 126 | 44 | 25 |
| % Reduction from Control | 0.0 | 69.0 | 77.7 |

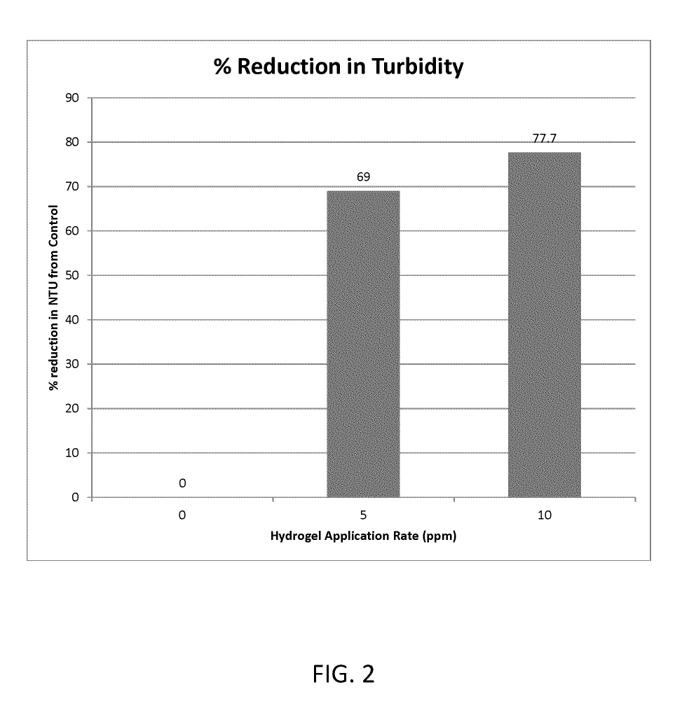

As shown above, the turbidity of the irrigation runoff water samples from the hydrogel treated soil plots were significantly lower than that of the control soil plots which were not treated with hydrogel (t-test p<0.02). FIG. 2 show a graph illustrating the average reduction in average irrigation runoff water turbidity level measurements compared to the control for each of control, 5 ppm and 10 ppm hydrogel treatment levels. In the case of the plots treated using the 5 ppm hydrogel application rate, the turbidity levels were about 69% lower than the control plots, and in the case of the plots using the 10 ppm hydrogel application rate, the turbidity levels were about 77.7% lower than the control plots.

In other embodiments, methods, gels and hydrogels of the disclosure may be combined with or modified by other methods, gels and hydrogels, such as those described in Patent Cooperation Treaty Patent Application Serial No. PCT/US2011/059837, which application is entirely incorporated herein by reference.

While several embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for reducing or preventing topsoil erosion, comprising:
a) providing a powdered hydrogel, said powdered hydrogel comprising a first polymeric material hydrogen bonded to a second polymeric material, wherein said first polymeric material includes polyacrylic acid and said second polymeric material includes a polyglycol other than polyethylene glycol;
b) applying said powdered hydrogel to a top surface of a plot of soil.

2. A method for reducing or preventing topsoil erosion, comprising:
a) providing a powdered hydrogel, said powdered hydrogel comprising a first polymeric material hydrogen bonded to a second polymeric material, wherein said first polymeric material includes polyacrylic acid and said second polymeric material includes a polyglycol other than polyethylene glycol;
b) mixing said hydrogel with water to form a liquid hydrogel;
c) applying said liquid hydrogel to a top surface of a plot of soil.

3. (canceled)

4. A method for reducing or preventing topsoil erosion, comprising:
a) providing a powdered hydrogel, said powdered hydrogel comprising a first polymeric material hydrogen bonded to a second polymeric material, wherein said first polymeric material includes polyacrylic acid and said second polymeric material includes a polyglycol other than polyethylene glycol;
b) mixing said hydrogel with an organic material and water to form a mixture;
c) applying said mixture comprising said hydrogel to a top surface of a plot of soil.

5. The method of claim 2, wherein said hydrogel applied to said top surface of said plot of soil reduces average annual soil loss by at least 1%, 2%, 3%, 4%, 5%, 10%, 20%, 30%, 40%, 50%, 60%, 70%, 80%, or 90%.

6. The method of claim 1, further comprising spraying water onto said plot of soil.

7. The method of claim 2, wherein the weight ratio of said powdered hydrogel to said water is in a range of about 1:100 to about 100:1.

8. The method of claim 4, wherein said organic material is selected from a group consisting of paper mulch, wood fiber mulch, recycled paper, and cellulose.

9. The method of claim 4, wherein the weight ratio of said powered hydrogel and said organic material is in a range of about 1:100 to about 100:1.

10. The method of claim 2, wherein the second polymeric material is polytetramethylene ether glycol.

11. The method of claim 2, wherein at least one of the first polymeric material and the second polymeric material is substantially a homopolymer.

12. The method of claim 2, wherein the hydrogel remains substantially unchanged after at least one of: one, two, or 50 hydration-dehydration cycles.

13. The method of claim 2, wherein the hydrogel has a water-retention capacity of at least one of: about 10%, 20%, 100%, 100%, 1000%, or 5000% of the weight of the hydrogel.

14. The method of claim 2, wherein the ratio, by weight, of the first polymeric material to the second polymeric material is at least one of: about 1-to-3 and about 1-to-6.

15. The method of claim 2, wherein the hydrogel further comprises a cross-linker.

16. The method of claim 2, wherein the hydrogel is formed without a catalyst.

17. The method of claim 2, wherein the Mw (g/mol) of the first polymeric material is between at least one of: about 250,000 to about 1,000,000, and about 400,000 and 600,000.

18. The method of claim 2, wherein the Mw (g/mol) of the second polymeric material is between at least one of: about 500 to about 2,000, and 650 and 1,000.

19. The method of claim 1, wherein the second polymeric material is polytetramethylene ether glycol.

20. The method of claim 1, wherein at least one of the first polymeric material and the second polymeric material is substantially a homopolymer.

21. (canceled)

22. The method of claim 2, wherein said hydrogel comprises a potassium salt of said first polymeric material crosslinked by hydrogen bonding to said second polymeric material.
